(19) United States
(12) Patent Application Publication
(10) Pub. No.: US 2026/0309841 A1
(43) Pub. Date: Oct. 8, 2026

(54) Absorber Device for a Radar Device of a Vehicle, Radar Device for a Vehicle, and Vehicle

(71) Applicant: Bayerische Motoren Werke Akiengesellschaft, Muenchen (DE)

(72) Inventors: Andreas BAUER, Teisnach (DE); Florian DIRNBERGER, Viechtach (DE); Thomas HOGGER, Otterfing (DE); Jonathan ROTH, Muenchen (DE); Johannes SCHWENDNER, Muenchen (DE)

(21) Appl. No.: 19/480,849

(22) PCT Filed: Aug. 14, 2024
(86) PCT No.: PCT/EP2024/072849

§ 371 Date: Nov. 3, 2025

(30) Foreign Application Priority Data
Aug. 18, 2023 (DE) 10 2023 122 120.5

(51) Int. Cl. G01S 7/03; G01S 13/88; H01Q 1/42

(52) U.S. Cl. CPC G01S 7/032; G01S 13/88; H01Q 1/42

(57) ABSTRACT

An absorber device for a radar device of a vehicle includes an absorber element for absorbing radar beams and a light source for emitting light beams. The light source is arranged on a first side of the absorber element. A light guiding element is integrated in the absorber element and is configured to guide the light beams out on a second side opposite the first side.

### BACKGROUND AND SUMMARY

The present invention relates to an absorber device for a radar device of a vehicle, including at least one absorber element for absorbing radar beams. Furthermore, the invention relates to a radar device having at least one such absorber device and to a vehicle having at least one such radar device.

Radar devices are used in automotive engineering to detect objects, such as other vehicles and/or pedestrians, and measure their distance to the vehicle and their relative velocities. For this purpose, the radar emits electromagnetic waves, which are reflected from the object to be detected and are received again by the radar and evaluated in control units. To reduce the scattering of misdirected electromagnetic waves, surrounding the radar using an absorber device, such as an absorber foam, is known.

For example, a radar arrangement for a motor vehicle is disclosed in DE 10 2020 133 970 A1. The radar arrangement comprises at least one printed circuit board including an antenna arrangement and a control unit, which operates the antenna arrangement to emit and receive radar beams, having a housing including a housing base body and a housing opening formed by housing side walls of the housing base body, wherein the printed circuit board is held in the housing base body, having an absorber, which partially covers the surface of the printed circuit board facing toward the housing opening while exposing the antenna arrangement, and having a radome arranged on the housing opening.

A radar device is usually arranged behind one of the kidney grilles of a vehicle front to measure a distance to a preceding vehicle and/or a pedestrian. In order that the appearance of the vehicle front is not impaired by the radar device, positioning a graphic, such as a vehicle emblem, in front of the radar device and illuminating it is known.

A radome cover is known from DE 10 2018 005 592 A1, which includes a first side and a second side connected thereto, wherein the first side consists of a material transparent to radar and/or lidar and the second side is formed from a potting compound which is transparent to radar and/or lidar and is cast on the first side. A three-dimensional decorative element is introduced in the first side, wherein the first side and decorative element are potted using the potting compound transparent to radar and/or lidar, wherein a light source for illuminating the decorative element is provided at or in the radome cover.

The present invention is based on the object of providing an absorber device, a radar device, and a vehicle which enable improved illumination of a graphic arranged in front of a radar device and at the same time have a reduced radar transmittance.

An absorber device, a radar device, and a vehicle having the features of the respective independent claims are proposed to achieve the object.

Advantageous designs of the absorber device are the subject matter of the dependent claims.

According to a first aspect of the invention, an absorber device for a radar device of a vehicle is proposed. The absorber device includes at least one absorber element for absorbing radar beams and at least one light source for emitting light beams, wherein the light source is arranged on a first side of the absorber element, and wherein at least one light guiding element is integrated in the absorber element, which is designed to guide the light beams out on a second side opposite to the first side.

Due to the integration of at least one light guiding element in the absorber element, it is possible to directly illuminate an object arranged on a radome, such as a graphic or an emblem. At the same time, the absorber element in combination with the light guiding element minimizes the radar-transmissive gaps, so that misdirected radar beams do not result in an incorrect picture. Moreover, it is possible to make the absorber element thicker due to the use of the light guiding element. Improved shielding is thus enabled.

The absorber device is advantageously arranged on a vehicle exterior, for example on a vehicle front or a vehicle rear. The absorber device can thus be integrated in a kidney grille of a vehicle or a vehicle headlight.

A first side is understood in the present case as the side facing toward the vehicle, in particular the vehicle front or the vehicle rear, or a rear side of the absorber element. The second side opposite to the first side is understood in the present case as the side facing toward the vehicle surroundings, for example a direction of travel, or a front side of the absorber element.

The emitted light beams are advantageously introduced into the light guiding element on the first side and guided out of the light guiding element on the second side.

In an advantageous design, the light guiding element includes a light inlet section for introducing the emitted light beams into the light guiding element and a light outlet section for guiding out the introduced light beams. The light inlet section is advantageously dimensioned such that radar-transmissive gaps are minimized and thus multiple reflection does not occur. The light inlet section is advantageously a part extending through the absorber element. The light inlet section can thus be designed as a cylinder which is circular in cross section or a cylinder which is rectangular in cross section. The light beams introduced into the light guiding element are guided out via the light outlet section and, for example, illuminate a lens, in particular an object arranged on the lens, such as a graphic or an emblem. The light outlet section advantageously has a planar section which extends in the vehicle transverse direction and/or in the direction of a vehicle vertical axis. The light inlet section and the light outlet section are advantageously made of a uniform material and are connected to one another in one piece.

In one advantageous design, the light inlet section has a diameter which is less than or equal to 4 mm, preferably less than or equal to 2 mm. The light inlet section is thus dimensioned such that the transmittance for radar beams is reduced and therefore multiple reflections and thus incorrect images do not occur.

In one advantageous design, the light outlet section is designed as a diffuser disk. By way of the diffuser disk, a lens, in particular an object arranged on the lens, such as a graphic or an emblem, can be extensively illuminated using light.

In one advantageous design, the light guiding element is coated. The coating ensures that the introduced light beams are guided through the light guiding element and do not emerge from the light guiding element before the light outlet section.

In one advantageous design, the light guiding element is produced from a polycarbonate (PC). The polycarbonate enables the light beams introduced into the light guiding element to be guided back out of the light guiding element with nearly identical strength. Moreover, a light guiding element produced from polycarbonate is cost-effective to produce.

In one advantageous design, the light source includes at least one light-emitting diode (LED). Energy-efficient and space-saving illumination is enabled in this way. The light-emitting diode can comprise a white light-emitting diode or a red, a green, and/or a blue light-emitting diode. The latter light-emitting diode is referred to as an RGB-LED. Alternatively, the light source can include an organic light-emitting diode (OLED).

In one advantageous design, the absorber device includes multiple light sources, wherein at least one guiding element is assigned to each light source.

In one advantageous design, the absorber element is produced from an expanded polypropylene (EPP foam). An absorber element made of an expanded polypropylene is cost-effective to produce and reliably shields from multiple reflections.

According to a further aspect of the invention, a radar device for a vehicle is proposed. The radar device includes at least one radar, at least one absorber device connected to the radar, and a radome, wherein the absorber device illuminates the radome.

In one advantageous design, the radome is a lens. Furthermore, an object, such as a graphic or an emblem, which is illuminated by the absorber device, is advantageously applied to the radome. Advantageously, a rear side of the radome is illuminated by the absorber device, in particular by the light beams emerging from the light guiding element.

In one advantageous design, the absorber device encloses the radome.

According to a further aspect of the invention, a vehicle is proposed which includes at least one radar device.

A vehicle, a radar device, an absorber device, and further features and advantages are explained in more detail hereinafter on the basis of an exemplary embodiment, which is schematically shown in the figures.

### BRIEF DESCRIPTION OF THE DRAWINGS

FIG. 1 shows a vehicle having a radar device.

FIG. 2 shows an enlarged top view of the radar device and an absorber device.

### DETAILED DESCRIPTION OF THE DRAWINGS

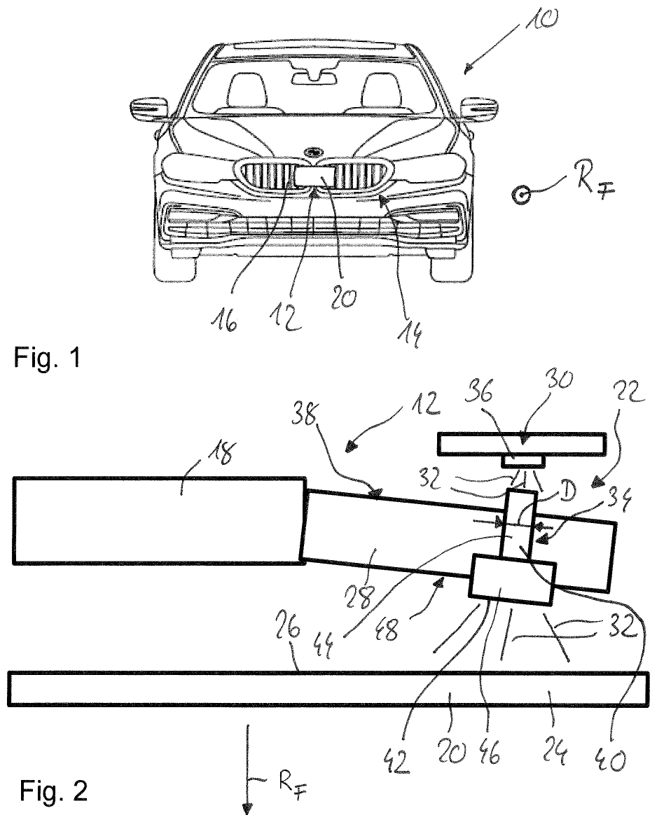

FIG. 1 shows a vehicle 10, which includes a drive machine designed as an internal combustion engine and/or as an electric motor.

The vehicle 10 comprises a radar device 12, which is arranged on a vehicle front 14 in the area of a kidney grille 16 in the direction of travel RF.

The radar device 12 is used to detect an object, such as another vehicle or a person, in order to measure their distance to the vehicle 10 and their relative velocity. For this purpose, the radar device 12 emits electromagnetic waves (not shown) in the direction of travel RF, which are reflected from the object to be detected and received by the radar device 12 and evaluated by way of a control unit (not shown).

As is apparent in FIG. 2, the radar device 12 includes a radar 18 for emitting and receiving radar beams, a radome 20, and an absorber device 22.

The radome 20 is a lens 24 which reflects radar beams. An object (not shown), such as a graphic or an emblem, is applied to the lens 24.

The absorber device 22 includes an absorber element 28 for absorbing radar beams, at least one light source 30 for emitting light beams 32, and at least one light guiding element 34 integrated in the absorber element 28.

The absorber element 28 is made of an expanded polypropylene (EPP foam) and is connected to the radar 18, as is apparent in FIG. 2. The absorber element 28 is used to shield the radar 18 in the direction of the vehicle 10, thus to the rear, from multiple reflections. Incorrect images are thus avoided.

The light source 30 includes a light-emitting diode 36 for emitting the light beams 32. As is apparent in FIG. 2, the light source 30 is arranged on a first side 38 of the absorber element 28. The first side 38 corresponds to a side of the absorber element 28 facing away from the direction of travel RF or a rear side of the absorber element 28.

The light guiding element 34 is produced from a polycarbonate (PC) and includes a light inlet section 40 for introducing the light beams 32 emitted by the light-emitting diode 36 into the light guiding element 34 and a light outlet section 42 for guiding out the light beams 32 introduced into the light guiding element 34. The light inlet section 40 and the light outlet section 42 are made of a uniform material and are connected to one another integrally, that is to say in one piece.

The light inlet section 40 is designed in the present case as a cylinder 44 which is circular or rectangular in cross section and has a diameter D, which is less than or equal to 4 mm, preferably less than or equal to 2 mm. As is apparent in FIG. 2, the cylinder 44 extends in the direction of travel RF.

The light outlet section 42 is designed as a diffuser disk 46, which extends in a vehicle transverse direction and/or a vehicle vertical axis. Via the diffuser disk 46, the light beams 32 introduced into the light guiding element 34 are guided out again on the second side 48, which is opposite to the first side 38 and faces toward the rear side 26 of the radome 20, and extensively guided onto the radome 20. The radome 20, in particular the object applied to the radome 20, such as a graphic and/or an emblem, is thus illuminated from the rear.

The absorber device 22 is distinguished by the integration of at least one light guiding element 34 in the absorber element 28. It is thus possible to directly illuminate an object arranged on the radome 20, such as a graphic or an emblem. At the same time, the absorber element 28 in combination with the light guiding element 34 minimizes the radar-transmissive gaps, so that misdirected radar beams do not result in an incorrect image. Moreover, it is possible due to the use of the light guiding element 34 to make the absorber element 28 thicker in order to thus enable improved shielding.

### LIST OF REFERENCE SIGNS

10 vehicle
12 radar device
14 vehicle front
16 kidney grille
18 radar
20 radome
22 absorber device
24 lens
26 rear side
28 absorber element
30 light source
32 light beams
34 light guiding element
36 light-emitting diode
38 first side
40 light inlet section
42 light outlet section
44 cylinder
46 diffuser disk
48 second side
RF direction of travel
D diameter

1.-10. (canceled)

11. An absorber device for a radar device of a vehicle, the absorber device comprising:
an absorber element for absorbing radar beams; and
a light source for emitting light beams, wherein:
the light source is arranged on a first side of the absorber element, and
a light guiding element is integrated in the absorber element, which light guiding element is configured to guide the light beams out on a second side opposite to the first side.

12. The absorber device according to claim 11, wherein the light guiding element includes a light inlet section for introducing the emitted light beams into the light guiding element and a light outlet section for guiding out the introduced light beams.

13. The absorber device according to claim 12, wherein the light inlet section has a diameter which is less than or equal to 4 mm.

14. The absorber device according to claim 12, wherein the light outlet section is configured as a diffuser disc.

15. The absorber device according to claim 11, wherein the light guiding element is coated.

16. The absorber device according to claim 11, wherein the light guiding element is produced from a polycarbonate.

17. The absorber device according to claim 11, wherein the light source comprises a light-emitting diode.

18. The absorber device according to claim 11, wherein the absorber element is produced from an expanded polypropylene.

19. The radar device comprising
a radar,
the absorber device according to claim 11, wherein the absorber device is connected to the radar, and
a radome, wherein the absorber device illuminates the radome.

20. The vehicle including the radar device according to claim 19.
